(19) United States
(12) Patent Application Publication
(10) Pub. No.: US 2014/0265385 A1
(43) Pub. Date: Sep. 18, 2014

(54) LADDER CARRYING HANDLE

(71) Applicant: Stephen A. Seifried, Mentor, OH (US)

(72) Inventor: Stephen A. Seifried, Mentor, OH (US)

(21) Appl. No.: 14/208,991

(22) Filed: Mar. 13, 2014

Related U.S. Application Data
(60) Provisional application No. 61/790,589, filed on Mar. 15, 2013.

(51) Int. Cl. B65G 7/12

(52) U.S. Cl. CPC B65G 7/12
USPC 294/16

(57) ABSTRACT

A ladder carrying handle has first and second bodies, each having an elongated portion and first and second arm portions extending from the elongated portion. The first and second arm portions each has a first portion extending at an angle from the elongated portion and a second portion extending at an angle with respect to the first portion, and a hook portion extending from a distal end of the second portion. The first and second bodies extend through a handle.

### CLAIM OF PRIORITY

This application claims priority from Provisional Patent Application Ser. No. 61/790,589, filed on Mar. 15, 2013, which is incorporated by reference herein in its entirety.

### BACKGROUND OF THE DISCLOSURE

This disclosure relates to a carrying handle assembly for carrying a ladder wherein the handle may be folded and stored when not in use but which is expanded to a carrying position and is secured to a ladder rail for carrying a ladder in a horizontal orientation.

Carrying ladders both of the spreading and extension types in a variety of positions can be awkward and may endanger the user. Because of the awkwardness in carrying ladders there is a difficulty in controlling them. Ladders are often caused to swing in undesirable directions causing damage to individuals and property. One of the carrying positions often employed is a two-handed attempt to carry the ladder in a horizontal position with the steps or rungs in upright position. This causes the possibility of danger of damaging the back of the user, and the ladder is difficult to control in relation to the body of the user. Other positions include carrying the ladder on the shoulder with the ladder positioned above or with the arm through the steps or rungs. Another position involves placing the ladder in horizontal position with the head projecting between the steps or rungs with the side rails resting on the shoulder. Any of these ways of carrying a ladder pose a risk of injury to the user and the possibility of dropping the ladder.

Thus, it is desirable to provide a foldable and easy to use ladder handle or caddy which overcomes the above-mentioned deficiencies and others when providing better overall results.

### SUMMARY OF THE DISCLOSURE

The disclosure relates to ladders. More particularly, it relates to a carrying handle for a ladder wherein the handle may be easily folded and stored when not in use.

In accordance with one aspect of the disclosure, a ladder carrying handle has first and second bodies, each having an elongated portion and first and second arm portions extending from the elongated portion. The first and second arm portions each has a first portion extending at an angle from the elongated portion and a second portion extending at an angle with respect to the first portion, and a hook portion extending from a distal end of the second portion.

In accordance with another aspect of the disclosure, a ladder carrying handle has an elongated member; a first arm extending from the elongated member at a first end of the elongated member; a second arm extending from the elongated member at the first end of the elongated member; a third arm extending from a second end of the elongated member; and a fourth arm extending from the second end of the elongated member. Each of the first, second, third, and fourth arms has a hook portion for retaining a portion of a ladder.

Another aspect of the disclosure is to provide a centrally disposed handle assembly for carrying ladders in common use including extension ladders as well as spreading ladders by attachment to one of the rails positioning the ladder carried horizontally with the steps or rungs in upright relation and carried by one hand of the user.

Another aspect of the disclosure is to provide a handle assembly which may be safely carried by one hand of the user while standing in erect position.

Another aspect of the disclosure is to provide a handle assembly wherein a comfortable handle is positionable over a balance point of the ladder to permit safely carrying the ladder below the waist.

Another aspect of the disclosure is a handle which may be folded or easily stored when not in use.

Still other aspects of the disclosure will become apparent upon a reading and understanding of the following detailed description.

### BRIEF DESCRIPTION OF THE DRAWINGS

The disclosure will be more readily understood from a reading of the following specification and by reference to the accompanying drawings forming a part thereof, wherein an example of the disclosure is shown and wherein:

FIG. 1 is a front perspective view of a ladder carrying handle in accordance with one aspect of the disclosure;

FIG. 2 is a side perspective view of the ladder carrying handle of FIG. 1 in an opened configuration;

FIG. 3 is a side perspective view of a ladder carrying handle of FIG. 1 in a closed configuration;

FIG. 4 is another side perspective view of the ladder carrying handle of FIG. 1 in an expanded configuration;

FIG. 5 is a side perspective view of a ladder carrying handle in accordance with another aspect of the disclosure; and

FIG. 6 is a side perspective view of a ladder carrying handle attached to a ladder in accordance with another aspect of the disclosure.

### DETAILED DESCRIPTION OF THE DISCLOSURE

Referring now to FIGS. 1-4, a ladder carrying handle assembly or caddy A in accordance with a preferred embodiment of the disclosure is shown. Specifically, ladder caddy A has an elongated handle 10 which is preferably formed as a hollow tube from metal or sturdy plastic and has an opening 11 therein extending along a longitudinal axis of the handle. A first hook arm assembly B extends through the handle and has an elongated horizontal portion 12 which extends through the handle opening 11. A first hook arm 14 and a second hook arm 16 extend from opposed ends of the portion 12 to form the hooks or retaining members for holding and retaining the ladder. Specifically, arm 14 has a first bent or angled portion 18 and a second straighter portion 20 extending downwardly from the angled portion 18. At a distal end of the second portion 20 is a hook or C-shaped portion 22 extending upwardly for retaining and securing a portion of a ladder rail or step. Portion 18 can be bent at a variety of angles such as 30 degrees, 45 degrees from horizontal, etc. Portion 20 likewise formed at an angle with respect to portion 18.

Similarly, second hook arm 16 has a first, angled or bent portion 24 and a second straighter portion 26 extending downwardly from portion 24 which has a hook or C-shaped portion 28 extending upwardly from a distal end thereof. First and second arms 14, 16 essentially align with each other and are parallel along a plane extending through both arms so as to both retain or hold a side rail of a ladder. A second hook arm assembly C has essentially the same structure as the hook arm assembly B as described above but is the mirror image thereof. Each part of the assembly C has a prime designation after the reference numeral for similar pieces as assembly B.

FIGS. 2-4 illustrate the handle assembly A from various perspectives. FIG. 2 shows the assembly A for the in use configuration. FIG. 3 shows the assembly A in a closed or storage configuration, and FIG. 4 shows the assembly A in a fully opened or expanded configuration.

Referring now to FIG. 6, the handle assembly A is shown in use with a ladder assembly E. Specifically, hooks 22, 28, 22′, 28′ extend under and around ladder rails 50, 52. Furthermore, arm portions 20, 26, 20′, 26′ partially enclose the rails 50, 52 and prevent the ladder from moving laterally with respect to the handle assembly A.

Referring now to FIG. 5, an alternate embodiment of the disclosure is shown. Ladder handle assembly or caddy D has an elongated handle member 30 which is formed as a hollow tube portion and has two sets of parallel arms or walls 32, 34, 36, 38 extending downwardly and vertically from opposing ends of member 30. Walls 32, 34, 36, 38 are welded or otherwise permanently secured to handle member 30. Alternatively, walls 32, 34, 36, 38 may be fabricated as one piece with member 30 or may be rotatably attached to member 30. Each arm or wall has an angled wall 40, 42 44, 46 extending upwardly therefrom at an angle of about 45 degrees or so and in opposite directions. Other angles are also contemplated by the disclosure. The walls 32, 34, 36, 38 would extend through two rails 50, 52 of a ladder E shown in FIG. 6 and retain or hold the rails. The handle of FIG. 5 would extend around the rails 50, 52 and hook under the rails and would carry the ladder in a similar fashion to the assembly A that is shown in FIG. 6. Handle assembly D is also fabricated of metal or rigid plastic.

Other shapes and configurations of ladder caddies are contemplated by the disclosure such as arms with ends bent at 90 degrees to each other or at other angles. The hooks may be curved, straight or angled.

The exemplary embodiment has been described with reference to the preferred embodiments. Obviously, modifications and alterations will occur to others upon reading and understanding the preceding detailed description. It is intended that the appended claims and exemplary embodiment be construed as including all such modifications and alterations.

1. A ladder carrying handle, comprising:
first and second bodies, each having an elongated portion and first and second arm portions extending from said elongated portion, said first and second arm portions each comprises a first portion extending at an angle from said elongated portion and a second portion extending at an angle with respect to said first portion, and a hook portion extending from a distal end of said second portion.

2. The ladder carrying handle of claim 1, wherein said first and second arm portions extend from opposite distal ends of said elongated portion.

3. The ladder carrying handle of claim 1, further comprising a handle having an opening therethrough, wherein said elongated portions of said first and second bodies extend through said handle opening.

4. The ladder carrying handle of claim 1, wherein said first portions of said first and second arm portions are substantially parallel to each other.

5. The ladder carrying handle of claim 1, wherein said second portions of said first and second arm portions are substantially parallel to each other.

6. The ladder carrying handle of claim 1, wherein said hook portions of said first and second arm portions are substantially parallel to each other.

7. The ladder carrying handle of claim 1, wherein said first portion of said first arm portion of said first body extends in an opposite direction from said first portion of said first arm portion of said second body.

8. The ladder carrying handle of claim 1, wherein said first portion of said second arm portion of said first body extends in an opposite direction to said first portion of said second arm portion of said second body.

9. The ladder carrying handle of claim 1, wherein said first body and second body are rotatable with respect to each other.

10. A ladder carrying handle comprising:
an elongated member;
a first arm extending from said elongated member at a first end of said elongated member;
a second arm extending from said elongated member at said first end of said elongated member;
a third arm extending from a second end of said elongated member; and
a fourth arm extending from said second end of said elongated member;
and wherein each of said first, second, third, and fourth arms comprises a hook portion for retaining a portion of a ladder.

11. The ladder carrying handle of claim 10, wherein said first and second arms are substantially parallel to each other.

12. The ladder carrying handle of claim 10, wherein said third and fourth arms are substantially parallel to each other.

13. The ladder carrying handle of claim 10, which said hook portions each comprise a wall bent upwardly with respect to one of said first, second, third, and fourth arms.

14. The ladder carrying handle of claim 13, wherein said wall of said first arm and said wall of said second arm are bent in an opposite direction relative to each other.

15. The ladder carrying handle of claim 13, wherein said wall of said third arm and said wall of said fourth arm are bent in an opposite direction relative to each other.

16. The ladder carrying handle of claim 10, wherein each of said first, second, third, and fourth arms are fastened to said elongated member.

17. The ladder carrying handle of claim 10, wherein said handle is fabricated from metal.

18. The ladder carrying handle of claim 1, wherein said handle is fabricated from metal.
